(19) United States
(12) Patent Application Publication
(10) Pub. No.: US 2024/0020774 A1
(43) Pub. Date: Jan. 18, 2024

(54) REDUCTION OF NITROGEN GREENHOUSE GAS EMISSIONS IN AGROECOSYSTEMS FOR PRECISION CONSERVATION

(71) Applicant: BOARD OF TRUSTEES OF MICHIGAN STATE UNIVERSITY, East Lansing, MI (US)

(72) Inventor: Bruno BASSO, East Lansing, MI (US)

(21) Appl. No.: 18/256,891

(22) PCT Filed: Dec. 9, 2021
(86) PCT No.: PCT/US2021/062703

§ 371 Date: Jun. 9, 2023

Related U.S. Application Data
(60) Provisional application No. 63/123,340, filed on Dec. 9, 2020.

(51) Int. Cl. G06Q 50/02; A01C 21/00; G06Q 30/018; G06Q 10/0631; G05B 15/02

(52) U.S. Cl. CPC G06Q 50/02; A01C 21/005; A01C 21/007; G06Q 30/018; G06Q 10/06313; G05B 15/02; A01C 23/047

(57) ABSTRACT

Nitrogen-based agricultural crop fertilizers are known to be a source of N2O emission, due to various direct and indirect processes. For example microbial activity, volatilization from spraying, volatilization from evaporative processes, and the like cause N2O emission. From a standpoint of environmental science, various “precision conservation” methods and adaptations to nitrogen fertilizer application can mitigate these processes. By reducing these processes, and thereby reducing greenhouse gas emissions, carbon credit programs can be leveraged.

### CROSS-REFERENCE TO RELATED APPLICATIONS

This application claims priority to U.S. Provisional Application No. 63/123,340, filed on Dec. 9, 2020, the entirety of which is incorporated herein by reference.

### STATEMENT REGARDING FEDERALLY SPONSORED RESEARCH

This invention was made with government support under 2015-68007-23133 awarded by the U.S. Department of Agriculture. The government has certain rights in the invention.

### FIELD

The present disclosure relates generally to the field of environmental sciences, and more particularly to the technological field of precision conservation, including precision conservation systems and methods for reducing carbon dioxide, nitrous oxide, and similar greenhouse gas emissions from fertilization operations in agricultural ecosystems.

### BACKGROUND

Most large scale, commercial crop, agriculture operations utilize nitrogen-based fertilizers, sprayed at one or more times during a growing season. These fertilizers are applied in a variety of ways, but some of the most common methods for row crops involve spraying water-born fertilizers. Regardless of the method of application, there are several ways that nitrous oxide (N₂O) emissions can occur, ranging from direct emission to indirect nitrogen loss.

Three common nitrogen fertilizer sources are anhydrous ammonia, urea and urea ammonium nitrate solutions (UAN). If applied properly, anhydrous ammonia can be a relatively stable nitrogen source, as it is the slowest fertilizer to be converted to nitrate. In contrast, urea is a comparatively unstable source, owning in large part to its susceptibility to volatilization losses. Volatilization of urea can occur rapidly depending upon weather and soil conditions, which can change quickly in uncertain climates. UAN solutions typically contain a mixture of urea and ammonium nitrate, meaning it can be partially subject to a variety of losses such as volatilization, leaching or denitrification.

Some studies have shown evidence that in some cases only about 40% to 60% of nitrogen applied is taken up by a crop. Another 20 to 30% can remain in the soil after harvest and 10 to 20% becomes unavailable to plants during the growing season. The losses are due to many factors, which can include volatilization, leaching and denitrification. Volatilization occurs when fertilizers containing urea undergo rapid hydrolysis in the soil. Significant losses of ammonia gas can occur. Nitrate-nitrogen is susceptible to losses from leaching and denitrification. Leaching is most likely to take place in coarse-textured soils. Denitrification of nitrate-nitrogen occurs under saturated conditions on fine-textured soils. Over 100 lbs. of nitrogen per acre can be lost from denitrification in five days under the proper conditions. Indirect N₂O emission can occur in several ways based upon these types of losses.

Direct N₂O emission from farms and other agricultural zones can be caused by soil microbial activity. This can include nitrification and/or denitrification, which (due to these processes being microbial in nature), are affected by multiple factors including some that can be controlled and some that cannot (temperature and rainfall).

Regardless of the formulations and application methods, nitrogen-based fertilizers cause the release of N₂O into the atmosphere. Nitrous oxide is recognized to be a potent greenhouse gas, similar to carbon dioxide and methane. The emission of nitrous oxide into the atmosphere has been correlated with contributing to global warming by trapping heat and destroying stratospheric ozone.

New data and sensing technologies have the potential for more effective precision agricultural methods and management systems, including more precise application of nitrogen-based fertilizer application. Improved application of nitrogen fertilizer through precision agriculture technologies can lead to co-increases in productivity, profitability, conservation, and environmental co-benefits at an agricultural site. These scientific and technological advances suggest a number of alternative pathways to more sustainable agricultural systems, including improved spatial and temporal management of existing cropping systems, as well as system changes that involve new crops and alternative land uses. While profitability of an agricultural site is dependent on costs and productivity of crop yield, reduction of greenhouse gas emission can allow for another factor to be taken into account in profitability: the value of farms participating in incentive programs, such as carbon cap and trade systems.

Therefore, it would be desirable to have a system and method which use verified, variable rate prescription maps, normalized by yield stability zones, to calculate N₂O emission reduction achieved through use of optimized prescription maps (e.g., based on IPCC method of emission factors, assuming that 1% of fertilizer applied is lost to N₂O). For example, it would be desirable to have systems and methods that achieve reduction of nitrogen greenhouse gas emissions in agro-ecosystems, such as by using yield stability maps, crop modeling, and/or remote sensing, and generate verifiable carbon credits maps from precision application of reduced nitrogen fertilizer.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows an example of a crop yield stability map for an agricultural plot of interest, optionally utilizing four categorizations of stability zones: unstable (U); low yield, but stable (LS); medium yield, but stable (MS); and high yield and stable (HS). It is to be understood that other categorization systems are contemplated, having different, more, and/or fewer designations.

FIG. 2 shows a large scale crop yield stability mapping, utilizing three zone categorizations, at four levels of zoom (A-D).

FIG. 3 shows a bar chart of historical yield data year over year for three categorizations of yield zones.

FIG. 4a is a perspective view from one embodiment of an operator's cab of a fertilization spreader utilizing a prescription map and generating an as-applied map, per the disclosure herein.

FIG. 4b shows an example of a prescription map per the disclosure herein.

FIG. 5 shows a set of maps indicating impacts on nitrogen (N) fertilizer application based upon use of systems and methods disclosed herein.

FIG. 6 is a flow chart illustrating steps of various methods in accordance with the present disclosure.

FIG. 7 is a block diagram showing various equipment and networks that implement the systems and methods described herein, including data flow paths among them.

FIG. 8 is a block diagram depicting the components of a subsystem or kit that may be part of, or retrofitted to, a fertilizer sprayer.

FIG. 9a is a set of maps showing various N savings and carbon credit values for an agricultural operation.

FIG. 9b is a set of maps showing various N savings and carbon credit values for an agricultural operation.

FIG. 10 is a set of maps showing prescription fertilization information and profitability information for an agricultural area of interest at a crop farm.

### SUMMARY

The present disclosure describes aspects and features of various systems and methods that improve upon several technological fields including precision conservation and agricultural equipment. These aspects and features may be embodied, combined and substituted in combinations and permutations as implemented for one or more specific applications.

In one respect, various methods are provided which may achieve some or all of the advantages described herein. For example, a method for reducing nitrogen application to agricultural land may comprise the steps of: determining yield stability for at least two zones of an agricultural land; generating a nitrogen fertilizer prescription for the agricultural land, comprising different fertilizer applications for the at least two zones; receiving an indication of nitrogen fertilizer application corresponding to the prescription; determining a reduction in nitrogen fertilizer from the indication; and selling carbon credits corresponding to the reduction in nitrogen fertilizer.

In another respect, various systems are provided which can include some or all of the features, components, connections, and software described herein. For example, a system for precision conservation may comprise: at least one processor; at least one memory in communication with the processor, having stored thereon a set of instructions which, when executed, cause the processor to: receive a request for a fertilizer prescription for a crop to be grown on an agricultural area of interest; determine a crop yield stability map for the agricultural area of interest; send at least one proposed prescription to a remote computer associated with the agricultural area of interest; receive data corresponding to at least one actual fertilizer application for the agricultural area of interest; and determine a reduction in greenhouse gas emission based upon the at least one fertilizer application.

In another aspect, a kit may be provided, which may comprise at least one processor; a connection for receiving location positioning system; a valve controller adapted to connect to valves of a fertilizer sprayer; and a memory connected to the processor, having a set of instructions stored thereon which, when executed by the processor, cause the processor to: obtain real time location information from the connection for receiving location positioning system; send control signals to the valve controller to adjust spray application of a fertilizer to be sprayed by the sprayer at zones of a farm according to a fertilizer prescription stored in the memory for that farm; and record data indicative of the applied amounts of fertilizer over the farm.

In another aspect, a method may be provided for optimizing utilization of farmland. The method may comprise obtaining information from a user concerning a farmland and attributes (including size, shape, and/or access requirements) of at least one alternative farmland purpose; determining a crop yield stability map for the farmland; determining a profitability map for the farmland based upon the crop yield stability map, crop commercial data, and farming cost data; selecting at least one section of the farmland having a low profitability compared to at least some of a remainder of the farmland, while still being suitable for the alternative farmland purpose; providing a visual depiction to the user of a location of the at least one subset, a baseline overall profitability of the farmland, and an alternative profitability of the farmland if the subset were no longer used for crop growth but instead for the alternative farmland purpose. Additional embodiments of this method may also include the alternative profitability of the farmland taking into account revenue generated through the alternative farmland purpose (such as through solar or wind power generation, generation of carbon credits, or the like). Further embodiments of this method may also provide alternative estimates of profitability based on a set of potential alternative farmland purposes, including solar power generation, wind power generation, native vegetation, or reduced crop growth, and a recommendation of an optimal alternative purpose for maximizing profitability of the farm.

### DETAILED DESCRIPTION

The various systems and methods disclosed herein embody and implement numerous advantageous features. A more efficient application of fertilizer to an agricultural unit results in reduced usage of fertilizer without sacrificing yield. This increases profitability for agricultural units. In addition, allowing the operator of the agricultural unit to select from among various parameters for developing a fertilizer prescription map can leverage the operator's direct knowledge of the agricultural land, helping to fill gaps in available data. Providing an automated system with prescription options presented in a user-friendly interface can allow for ease of coordinating user preferences, while optimizing many environmental and conservation factors. Water quality is improved from reduced nitrogen losses, soil organic carbon sequestration is increased from the a reduced amount of soil disturbance (no tillage in locations that are prescribed for no planting), perennial vegetation cover and perennial root system from curated or native species, carbon credits from the abatement of GHG emission for no fertilizer N applied to these areas as described in the prescription map.

The reduction of N fertilizer in accordance with the systems and methods herein is based on the difference between N applied to high stable zones (the highest amount) and the N applied to Low, Medium and Unstable Zones through a verified machine-readable file.

A method has been developed which can determine the likelihood that a given area within an agricultural field will provide similar yields year after year. If sections of a field consistently produce high, medium, or low yields, then they may be characterized as high-and-stable (HS), medium-and-stable (MS), or low-and-stable (LS) zones, respectively. If crop productivity on a given area continually fluctuates between high and low yields from year to year, then it may classified as an unstable (U) zone. It is to be understood that more or less granularity (e.g., more or fewer levels of classification) can be utilized to classify zones of an agro-ecosystem.

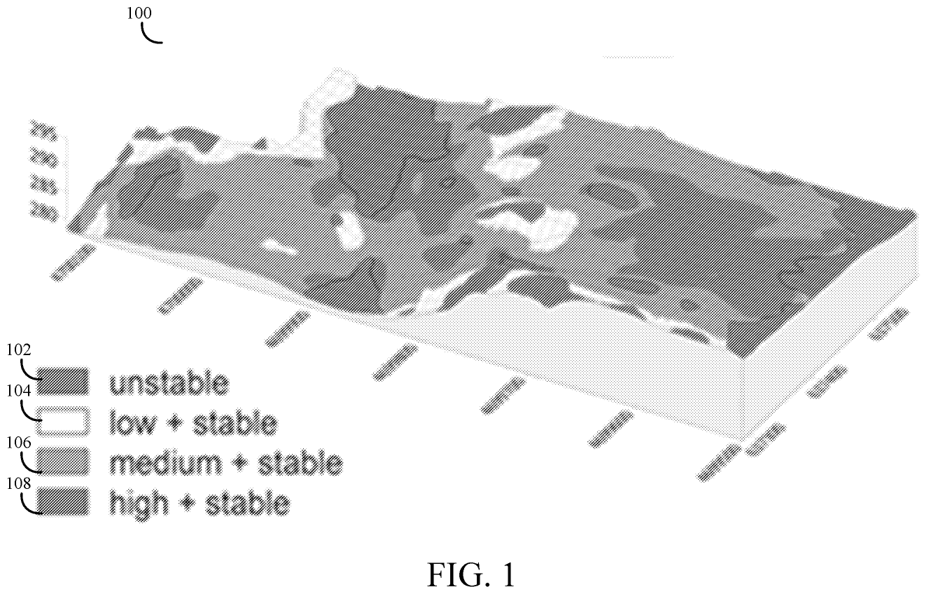

Referring now to FIG. 1, an exemplary stability map 100 is shown. As shown, the map 100 depicts, on a geographic/location and topographic/elevation basis, zones of the land of interest that exhibit four different categorizations of yield stability: unstable 102, low+stable 104, medium+stable 106, and high+stable 108. In one implementation, the map may be created based on use of satellite imagery (e.g., at various resolutions, including 30 m resolution, 2 m resolution, or other available resolutions) of an agro-ecosystem, alone or together with additional data. In one study performed by the inventor, corn and soybean growth was measured utilizing satellite imagery across ˜70 million acres in a 10-state region over ten years (2010-2019). Approximately 46% of the cropland in the Midwest was classified as high+stable, 26% as low+stable, and 28% as unstable.

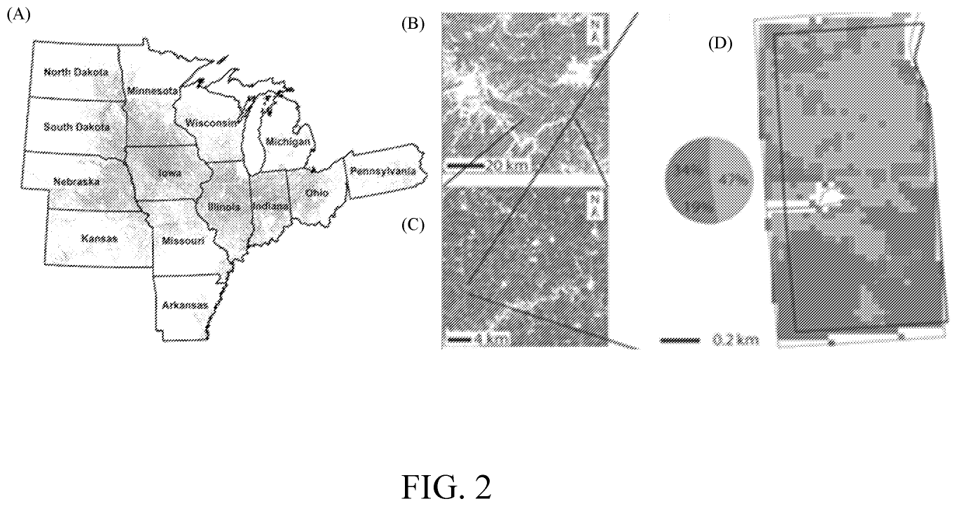

As shown in FIG. 2, an analysis of yield stability and productivity can be performed for multiple discrete fields over a large area, such as the Midwest region shown in panel A. In one example, the analysis was performed at a field level basis for over 8 million fields across the upper Midwest, and as shown in panels B and C, at various areas of interest at varying scales (e.g., 100 km², 20 km² or 4 km²). The analysis can also be done over all or a portion of a given farm parcel, as shown in panel D (which only analyzes the crop growth areas of a given farm parcel). These estimates were verified against data from growers' combine yield monitors (at 2 m resolution) of thousands of corn fields across the region.

From the above-mentioned study, it was determined that yield stability tightly correlates with profits; that trend held across most of the analyzed fields. Tables 1-4 below, show exemplary data generated by an analysis of yield stability and productivity for an 80M acre area of the upper Midwest.

TABLE 1

| | | Percentage of area (%) | | | | | | Class (%) | |
|---|---|---|---|---|---|---|---|---|---|
| | | Stable | | Stable | | Unstable | | High | Low |
| State | Area | high yield | | low yield | | yield | | yield | Yield |
| Arkansas | 145,310 | 32 | (±36) | 18 | (±26) | 50 | (±31) | 55 | 45 |
| Illinois | 6,516,484 | 47 | (±7) | 30 | (±5) | 23 | (±8) | 64 | 36 |
| Indiana | 3,153,424 | 41 | (±7) | 25 | (±4) | 34 | (±10) | 64 | 36 |
| Iowa | 7,497,549 | 51 | (±8) | 31 | (±8) | 19 | (±14) | 69 | 31 |
| Kansas | 869,220 | 59 | (±16) | 29 | (±9) | 12 | (±14) | 57 | 43 |
| Michigan | 121,673 | 38 | (±11) | 24 | (±10) | 38 | (±17) | 64 | 36 |
| Minnesota | 3,894,599 | 51 | (±8) | 23 | (±6) | 26 | (±11) | 67 | 33 |
| Missouri | 1,414,243 | 41 | (±10) | 29 | (±8) | 30 | (±15) | 61 | 39 |
| Nebraska | 4,468,594 | 66 | (±6) | 31 | (±6) | 3 | (±3) | 52 | 48 |
| North Dakota | 704,829 | 50 | (±13) | 19 | (±12) | 31 | (±14) | 67 | 33 |
| Ohio | 1,830,759 | 42 | (±8) | 27 | (±7) | 31 | (±13) | 62 | 38 |
| Pennsylvania | 197,683 | 54 | (±6) | 34 | (±4) | 12 | (±7) | 57 | 43 |
| South Dakota | 2,064,051 | 51 | (±14) | 22 | (±11) | 28 | (±19) | 68 | 32 |
| Wisconsin | 867,204 | 52 | (±5) | 31 | (±3) | 16 | (±5) | 68 | 32 |

| | | | | | |
|---|---|---|---|---|---|
| Average | 48 | 27 | 25 | 63 | 37 |

TABLE 2
Percentage of Stability Zones

| | | | | | Unstable Categories | | |
|---|---|---|---|---|---|---|---|
| | Area | High | Low | Unstable | Depression | Hilltop | Slopes |
| State | (ha) | (%) | (%) | (%) | (%) | (%) | (%) |
| Arkansas | 145,310 | 31.98 | 17.68 | 50.34 | 3.52 | 5.37 | 41.45 |
| Illinois | 6,515,442 | 50.26 | 31.49 | 18.25 | 3.24 | 3.73 | 11.28 |
| Indiana | 3,153,424 | 45.37 | 25.43 | 29.20 | 6.29 | 6.29 | 16.62 |
| Iowa | 7,497,549 | 54.66 | 31.13 | 14.21 | 4.28 | 4.14 | 5.79 |
| Kansas | 869,220 | 58.86 | 29.12 | 12.02 | 2.02 | 3.30 | 6.70 |
| Michigan | 121,674 | 43.02 | 24.60 | 32.38 | 6.54 | 7.19 | 18.65 |
| Minnesota | 3,894,599 | 54.71 | 25.62 | 19.68 | 5.72 | 5.17 | 8.79 |
| Missouri | 1,414,243 | 43.83 | 28.96 | 27.22 | 4.54 | 6.82 | 15.86 |
| Nebraska | 4,468,594 | 66.10 | 31.23 | 2.67 | 0.71 | 0.75 | 1.21 |
| North Dakota | 704,829 | 50.86 | 13.48 | 35.66 | 5.56 | 6.70 | 23.40 |
| Ohio | 1,830,759 | 42.36 | 25.13 | 32.51 | 6.25 | 6.33 | 19.94 |
| Pennsylvania | 196,088 | 54.02 | 34.67 | 11.31 | 4.18 | 4.84 | 2.29 |
| South Dakota | 2,064,051 | 53.20 | 19.99 | 26.82 | 5.55 | 6.25 | 15.01 |
| Wisconsin | 867,204 | 55.48 | 30.97 | 13.54 | 3.81 | 3.68 | 6.06 |

TABLE 3
N removed by harvest, N fertilizer surplus, and apparent N use efficiency (NUE) within yield stability classes

| | | Harvested N | | | Surplus N | | | NUE | | |
|---|---|---|---|---|---|---|---|---|---|---|
| | Fertilizer N | Stable | Stable | | Stable | Stable | | Stable | Stable | |
| State | Rate | High | Low | Unstable | High | Low | Unstable | High | Low | Unstable |
| IL | 179-229 | 145 | 108 | 131 | 34-84 | 71-121 | 48-98 | 63-81 | 47-60 | 57-73 |
| IN | 168-251 | 135 | 99 | 122 | 44-116 | 69-152 | 46-129 | 54-80 | 39-59 | 49-73 |
| IA | 152-208 | 148 | 115 | 138 | 4-60 | 37-93 | 14-70 | 71-97 | 55-76 | 66-91 |
| MI | 143-198 | 131 | 95 | 118 | 12-67 | 48-103 | 25-80 | 66-92 | 48-66 | 60-83 |
| MN | 154-212 | 145 | 115 | 135 | 9-67 | 39-97 | 19-77 | 68-94 | 54-75 | 64-88 |
| MO | 189-260 | 118 | 85 | 105 | 71-142 | 104-175 | 84-155 | 45-62 | 33-45 | 40-56 |
| ND | 137-190 | 111 | 83 | 102 | 26-79 | 54-107 | 35-88 | 58-81 | 44-61 | 54-74 |
| OH | 155-234 | 136 | 100 | 122 | 19-98 | 55-134 | 33-112 | 58-88 | 43-65 | 52-79 |
| SD | 134-182 | 118 | 89 | 109 | 16-64 | 45-93 | 25-73 | 65-88 | 49-66 | 60-81 |
| WI | 111-155 | 132 | 100 | 122 | 0-23 | 11-55 | 0-33 | 85-119 | 65-90 | 79-110 |
| Total | 152-212 | 132 | 99 | 120 | 22-80 | 55-113 | 33-92 | 63-88 | 48-66 | 58-81 |
| Average | | | | | | | | | | |

TABLE 4
Surplus fertilizer N Loss from stable and unstable low yield areas and its
monetary value, embedded energy, and associated CO₂-equivalent emissions.

| | Surplus N Loss | Monetary Value | Embedded Energy | CO_{2eq} Emissions |
|---|---|---|---|---|
| State | (Gg y⁻¹) | (million USD y⁻¹) | 10⁶ GJ y⁻¹) | (Mt y⁻¹) |
| IL | 192-380 | 80.6-159.5 | 13.4-26.6 | 1.2-2.3 |
| In | 88-241 | 36.9-101.1 | 6.1-16.9 | 0.5-1.5 |
| IA | 87-304 | 36.6-127.6 | 6.1-21.3 | 0.5-1.8 |
| MI | 6-17 | 2.3-7.0 | 0.4-1.2 | 0.0-0.1 |
| MN | 54-204 | 23.9-85-8 | 4.0-14.3 | 0.3-1.2 |
| MO | 72-132 | 30.3-55.6 | 5.0-9.3 | 0.4-0.8 |
| ND | 35-85 | 14.7-35.7 | 2.6-5.9 | 0.2-0.5 |
| OH | 40-133 | 16.7-55.8 | 2.8-9.3 | 0.2-0.8 |
| SD | 51-134 | 21.3-56.1 | 3.5-9.3 | 0.3-0.8 |
| WI | 8-43 | 3.6-18.1 | 0.6-3.0 | 0.1-0.3 |
| Total Average | 155 (636-1673) | 485 (267-702) | 78.8 (45-113) | 6.8 (3.5-10.1) |

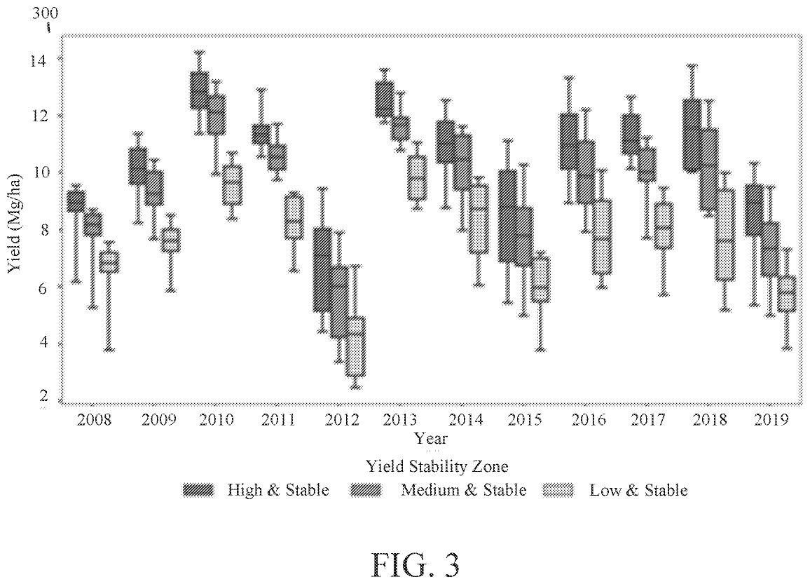

Referring now to FIG. 3, a graph 300 is shown depicting the results of an analysis of yield response to fertilizer application. FIG. 3 depicts bands of measured yield response year over year in 67 fields in Michigan, to uniform N fertilizer application (average 198 kilograms nitrogen per hectare (kg N/ha)). FIG. 3 provides measured evidence of the lower yield response to fertilizer applied to low+stable zones for 67 fields combined in Michigan. In other words, despite a full application of N fertilizer, the LS zones consistently do not achieve as high a yield as the HS or MS zones. In comparison when a typical or standard application of the same amount of fertilizer is applied to medium or high stable zones, the response is much higher.

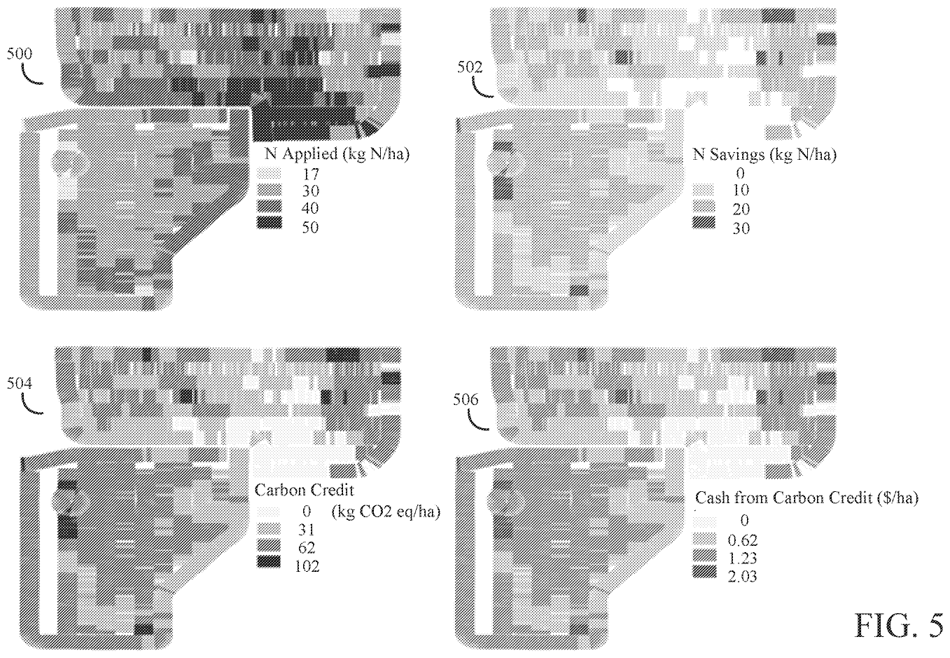

FIG. 5 depicts another example of yield stability and fertilizer prescription maps for a field with 11 years of yield map data and economic information provided by the farmer. The first map 500 shows varying rates of N applied over an agro-ecosystem. The second map 502, shows N savings due to the varied application of fertilizer over the same agro-ecosystem. The third map 504 shows the amount (in kg) of carbon equivalent reduction, due to the varied fertilizer application. The fourth map 506 shows the contribution to cash value of carbon credits that can be obtained due to the reduction of fertilizer over the agro-ecosystem. Thus, positive revenue from reduction of carbon equivalent can be determined on a spatial/geographic basis. This factor can be utilized, along with other cost and revenue information ascertained on a spatial/geographic basis to generate profitability maps for a farm that compare profitability of using N prescriptions versus standard or uniform N application. As depicted, the revenue values in FIG. 5 are classified in zero, low, medium, and high to show in a more simplified way observed averages through time and their consistent behavior (low N application, for instance indicates that there is always only small production over time from those areas, and so they should not be given as much N fertilizer), however it is to be understood that a more or less precise categorization is possible, such as color mappings of exact dollar values according to a gradient color intensity.

Based on the knowledge ascertained from the above-referenced studies and further analysis performed by the inventor, systems and methods have been developed for implementing precision conservation methods across one or more agroecosystems, such as an individual farm, or a group of managed farm lands, a county or other governmental unit, or customers of farm equipment or farm management services. The systems and methods described herein allow those managing the agroecosystems to reduce collective utilization of N fertilizer in a targeted and informed way, to maximize yield of better performing zones of an agroecosystem, to minimize expenditures and reduce losses in poorer performing zones, and to capture value from reduced fertilizer use through carbon offset credits. For example, one method is based on an integrated geospatial system that helps predict yield and N requirements in HS zones and to understand the underlying causes for the poor performance of the LS or U zones and design appropriate strategies to manage them. This data-driven platform capitalizes on the strengths of three major precision technologies (remote sensing, crop modeling, and yield stability analysis) to deliver a turn-key solution to farmers in the form of N application rate prescription (Rx) maps for easy implementation in the field. These big-data analytics have been shown to increase resource use efficiency, environmental sustainability, and profitability for the producers.

In one implementation, a method first determines a yield stability map using one or multiple techniques: e.g., from grower yield monitor data, using airborne or satellite imagery, or both. Then the method develops an N fertilizer map corresponding to the different stability zones. In one implementation, nitrogen fertilizer rates may be determined using the validated SALUS model for each yield stability zone to spatially account for the implicit variability of soil N mineralization rates, and losses of nitrates to deeper layers in each field.

The SALUS model is described by way of illustration, but other crop models known in the art also may be used, for example including CROPGRO for major grain legumes, CERES for cereal crops, and SUBSTOR for crops with belowground storage organs, all of which are available in the Decision Support System for Agrotechnology Transfer (DSSAT) suite of crop models used to simulate crop biomass and yield as influenced by weather, soil, crop management, and crop genotype.

The Systems Approach to Land Use Sustainability (SALUS) is similar to the DSSAT family of models, but further simulates yields of crops in rotation as well as soil, water and nutrient dynamics as a function of management strategies over multiple years. SALUS accounts for the effects of rotations, planting dates, plant populations, irrigation and fertilizer applications, and tillage practices. The model simulates daily plant growth and soil processes on a daily time step during the growing season and fallow periods. SALUS contains (i) crop growth modules, (ii) soil organic matter (SOM) and nutrient cycling modules, and (iii) soil water balance and temperature modules. The model simulates the effects of climate and management on the water balance, SOM, nitrogen (N) and phosphorous (P) dynamics, heat balance, plant growth, and plant development. Within the water balance, surface runoff, infiltration, surface evaporation, saturated and unsaturated soil water flow, drainage, root water uptake, soil evaporation, and transpiration are simulated. Soil organic matter decomposition, along with N mineralization and formation of ammonium and nitrate, N immobilization, and gaseous N losses are also simulated.

Crop development in the SALUS model is based on thermal time calculations modified by daylength and vernalization. Potential crop growth depends on intercepted light using solar radiation data and simulated LAI, and is reduced by water or nitrogen limitations. The main external inputs for the crop growth simulations are the plant genetic coefficients and climate data (e.g., daily solar radiation, precipitation, and air temperature). The SALUS model simulates SOM and N mineralization/immobilization from three soil organic carbon pools (active, slow, and passive) that vary in their turnover rates and characteristic C:N ratios. A soil P model incorporates inorganic P (labile, active, and stable) and organic P dynamics. The soil water balance calculates infiltration, drainage, evaporation, and runoff.

Input data to the SALUS model includes weather, soil and crop management activities, soil properties, genetic characteristics of the crop, and the site location. SALUS accounts for weather variability by using up to several decades of existing weather information to represent a historical weather data period. Daily totals of rainfall and solar radiation along with the maximum and minimum temperature over the historical weather data period provide a relatively accurate crop simulation. Weather data is preferably obtained at a site near the area where the crop model is to be applied, especially for daily rainfall. Temperature and radiation are more spatially uniform, so the weather station need not be on site. Most weather stations record rainfall and temperature but not always solar radiation. Accurate solar radiation data can be obtained from NASA (e.g., directly via an internet connection) with a spatial resolution in 1-degree grid cells. This NASA data source also provides all of the daily weather data input for the SALUS model with the same spatial resolution issues as with solar radiation. Soil input properties include the lower limit of available soil water, the field capacity or drained upper limit (DUL) water content, soil texture, soil bulk density, and soil organic matter content. Irrigation input characteristics include the dates, amounts, and mode of application. The crop variety, genotype, or cultivars also are specified, for example with wheat and corn cultivar information generally being expressed as genetic coefficients, which allow models to simulate crop phenology over a wide range of latitudes and planting times. A modeling method such as SALUS can be used to determine optimal (or optional) N-fertilizer rates and applications on a spatial distribution basis over the area of an agro-ecosystem (farm, co-op, county, etc.), by simulating in each of the stability zones the rates of N-fertilizer that do not impact yield (or only cause a minimal or acceptable impact to yield when considering other factors, such as overall profitability) while reducing N losses. The underlying stability maps and analyses may be generated from analysis of data from yield monitor (yield maps) or from imagery.

The variable rate prescriptions for each fertilization cycle of a given farm are spatially assigned—in other words, fertilizer application is prescribed on a zone-by-zone basis with high specificity. In one example, a prescription map was developed with resolution on a 2 m² basis. The prescription maps can be generated using the SALUS model to determine which zones would likely benefit (and how much) from various levels of N fertilizer application, and then supplemented or modified on in-season remotely sensed imagery, feedback from the farmer or manager of the land, changes to intended irrigation amounts/timing, weather, or the like. For example, in one embodiment, areas of low reflectance in remote sensing/imaging (indicative of poor plant health, or more bare soil visible because the plants were not present or have not grown as rapidly or fully), can be identified in historical data. Based upon yield modeling, the systems and methods described herein can determine how much (if any) N fertilizer to apply to those zones versus medium or high zones. For example, LS zones that have been determined to have consistently low yield may be prescribed to receive little to no N fertilizer at the initial fertilizer application as well as some or all subsequent fertilizer application cycles (if any). This is because it is determined that those zones are not producing a worthwhile yield in recent seasons. And, reflectance can continue to be monitored during a season remotely. For LS zones that have not responded well to initial fertilizer applications (as determined by low reflectance), subsequent applications of N fertilizer can be cancelled altogether or reduced.

For unstable zones, an initial application of fertilizer can be made based upon modeling from historical data. Then, in-season monitoring of reflectance can aid in determining whether and how much additional N fertilizer should be applied. If a historically-unstable zone exhibits signs of good growth in a given season, then additional N fertilizer may be applied. If a historically-unstable zone exhibits signs of poor growth (e.g., low reflectance), then additional N fertilizer may be avoided.

The areas of high reflectance, as a result of good plant health, will receive higher rates of N fertilizer (and typically be found in HS and MS zones). In other words, areas or zones of a farm or other agro-ecosystem that exhibit high reflectance can be interpreted as corresponding to high yield/stable zones. This is because these zones have better soil/topographic conditions and, as a consequence, generally produce higher yielding plants on a consistent basis. In comparison, zones of low reflectance are the result of poor optical remotely sensed vegetation indices, and thus can be interpreted as low yield/stable zones. Reflectance data for in-season growth can be used to determine which areas will best respond to a prescription map modeling (such as SALUS) to determine the best N rates for maximum reduction in N loss and better overall profitability. In some embodiments, however, reflectance data is not converted directly to N-fertilizer prescription rates. Rather, reflectance data may be used to inform where to utilize the SALUS model to determine optimal N rates for yield and lower N losses. Historical reflectance data can be used to develop stability maps, and in-season reflectance data can be used to generate a prescription map for that specific season.

In other embodiments, a sustainability index (e.g. a sustainability score given to a specific zone) may be utilized directly for N fertilizer prescription. The sustainability index is based on the ranking of site-specific results such as crop yield, nitrogen use efficiency (“NUE”), water use efficiency (“WUE”), surface water runoff (or just “runoff”), nitrate leaching (or just “leaching”), soil organic carbon change (or “C % change”), carbon dioxide emission, and nitrous oxide emission. These values can be obtained by running a crop model for a long-term time period (e.g., 5 or 10 to 20 or 30 years), to determine the distribution of the different results and to rank with scores the different percentiles (from low to high) of different simulated variables. Each percentile is assigned a score (e.g., 1 being low to represent a poor or undesirable value, 2 being high to represent a good or desirable value). This calculation is done for all the dependent variables incorporated into a given sustainability index definition. Based on the classification by zone of a farm, an application of fertilizer can be prescribed. Zones with high nitrogen use efficiency, good water use efficiency, low runoff, low nitrate leaching and low emission of carbon dioxide and/or nitrous oxide may be given comparatively higher levels of N fertilizer.

The variable rate prescription can be converted to a shapefile or other suitable map-based file for use by a fertilizer application equipment, and sent electronically to the farmers. The Rx N prescription maps will be applied using a variable rate applicator—the prescriptions can take the form of electronic files that instruct the operator or the equipment itself (in an automated or autonomous mode of operation) to vary the rate at which fertilizer is mixed with a carrier, to vary the pressure/flow of dissolved/carried fertilizer, vary the speed of the application equipment (e.g., it moves more quickly over LS zones), or to simply prescribe the travel path of the application equipment (e.g., it altogether skips LS zones, or only travels over them for a subset of the all/regular fertilizer applications).

As described herein the number of zones for prescription fertilizer application within a farming location may be set by a user (e.g., for purposes of coordination with the abilities of available spreader equipment, or for other preferences), or may be determined by a system or method that is providing the prescription map. The number of zones may be as low as two (e.g., “high” and “low” yield zones), may be three (e.g., “high”, “medium,” and “low”), may be four (e.g., “high,” “medium,” “low”, and unstable), may be five (e.g., “high,” “medium-high,” “medium-low,” “low,” and unstable) or may include other variations (including “somewhat unstable,” “very unstable,” “unstable high yield,” “unstable medium yield,” “unstable low yield,” or the like). Additionally, a farmer may have the ability (e.g., via a web portal, mobile app, control display of a spreader truck, or other user interface) to change the zone categorization for some or all of one or more zones within a prescription map, or to request more zone categorizations (e.g., adding “medium-high”, “medium-low”) or fewer zone categorizations be used.

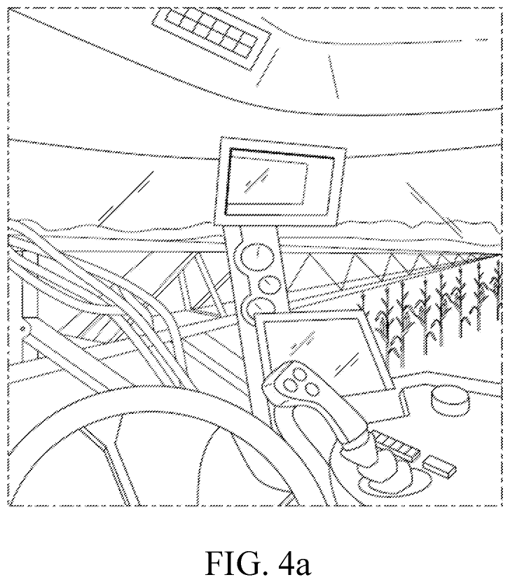

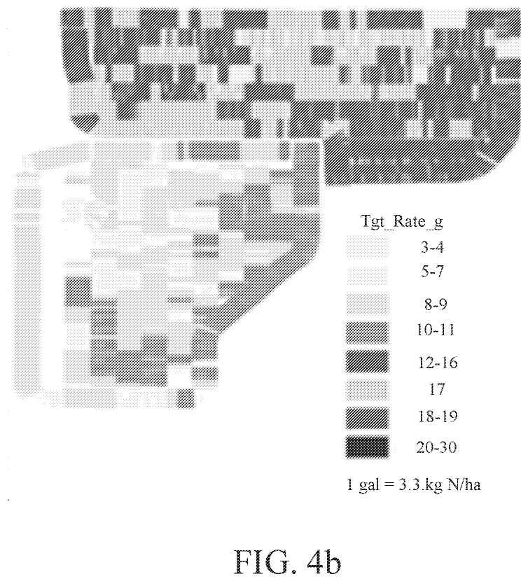

Referring now to FIGS. 4a and 4b, an “as applied map” of N fertilizer is shown in FIG. 4b together with an image of its use by a variable rate fertilizer equipment in FIG. 4a. The shading of the as-applied map of FIG. 4b corresponds to target application rates, “Tgt_Rate_g”. Some zones within the map were targeted for no fertilizer application at all (e.g., a fertilizer applicator could skip those zones, or selectively close the corresponding valves of a boom as it passes over the zones)—these would correspond to zones determined to have a consistently low yield in a stability map, or would otherwise be predicted to have essentially no response to N fertilizer (e.g., susceptible to high rates of leaching and/or runoff, with low N uptake efficiency). In other implementations, zones with a poor but still measurable predicted response to N fertilizer may still have been designated for no fertilizer application. In these circumstances it may be determined that the profitability of the fertilized yield from that zone did not justify applying the fertilizer. Instead, the predicted profit from cost savings from reduced fertilizer usage (including reduced water consumption, reduced time on the fertilizer applicator equipment, reduced N usage, etc.), the value of unfertilized yield, and the value of carbon offset credits may still be more valuable. In a similar way, use of the prescription map provided for high rates of application of fertilizer (dark blue) for zones that have historically produced consistently high yields (or which were determined to have positive sustainability index values).

FIG. 5 shows a set of maps that help visually illustrate profitability. FIG. 5, panel a depicts actual N applied across a farm. This “as-applied” data can be obtained from the application equipment itself, and is generated in real time during fertilizer application. FIG. 5, panel b depicts N saving over the farm. In one implementation, the N savings can be calculated as the difference between the highest application and actual application of fertilizer on a zone-by-zone basis. Thus, the savings would be ‘0’ for the zones in which the highest fertilizer application was made (50 kg N/ha minus 50 kg N/ha), ‘50’ for the zones in which no fertilizer application was made (50 kg N/ha minus 0 kg N/ha), and ‘33’ for zones in which the lowest application of fertilizer was made (50 kg N/ha minus 17 kg N/ha). FIG. 5, panel c depicts a CO2 equivalent reduction based upon the N savings. As is understood in the art, application of N fertilizer corresponds to release of N₂0 or equivalent greenhouse gases into the atmosphere. Thus, an assumed savings of greenhouse gas emissions can be calculated from reduced N usage. Finally, FIG. 5, panel d depicts an expected value on a zone-by-zone basis of carbon offset credits which could be sold. In one example, the calculated Carbon Credits may be valued at the current California trade and cap price of (e.g., $20/ton of C or equivalent).

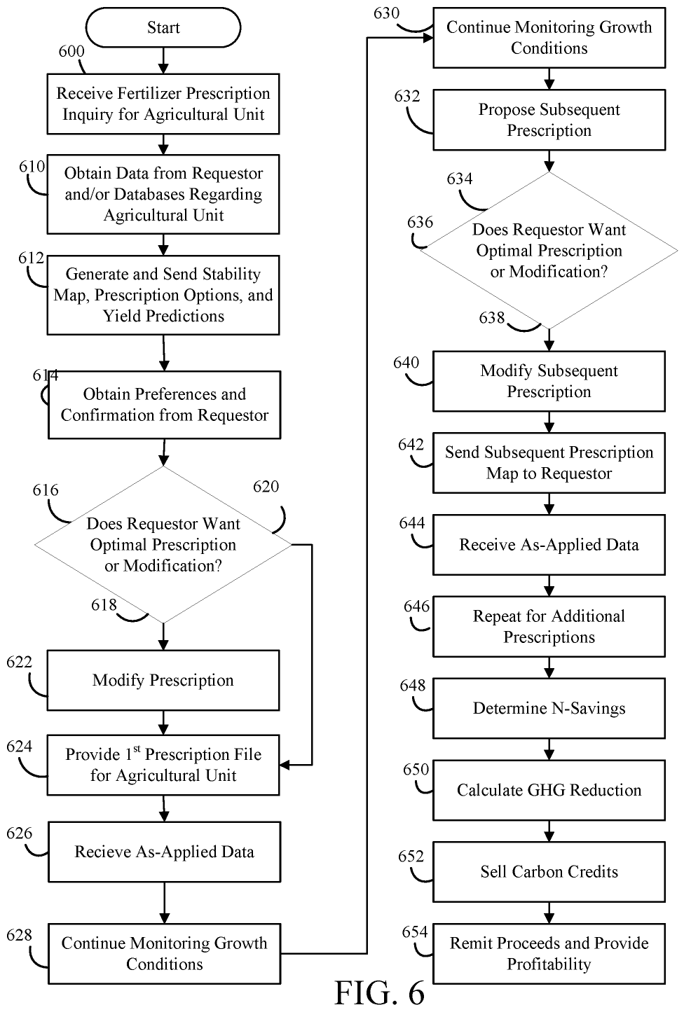

Referring now to FIG. 6, a flowchart is shown depicting the steps of a method in accordance with the various features and advantages described herein. The method 600 may be performed by a company providing prescription map services to farms, by a company that sells or operates farm equipment, by a farm management organization that offers fertilization services, a farm owner, or other businesses and contractors. At step 610, a request is received for a prescription map for a given agroecosystem (this could be an individual farm, an organization of multiple farms, a county, or other interested party). The request may be received via any suitable means, including a web portal, through a sales representative, by phone, through a request for bids, or the like. At step 612, additional data regarding the land to be prescribed is requested and obtained. In some embodiments, this step may be combined with step 610. Requested data may include: elevation data to calculate terrain attributes (slope, profile curvature, aspect catchment areas), historical climate data (solar radiation, temperature, precipitation) crop type, crop variety, crop maturity date, irrigation plan, historical yield data, historical fertilizer applications, historical planting cycles, projected planting date, projected type of fertilizer to be used (including, e.g., N content of the fertilizer, brand, source, etc.), number of projected fertilizer applications and timing, presence or absence of tile drains in the soil, historical weather calculated in terms of probability of occurrence, and the like. Data is also obtained from other sources at this step 612, including historical satellite or other remote sensing data, historical weather data, and other data useful for generating a stability map for the land of interest.

At step 614, one or a group of files and information may be generated for the subject land and sent to the requestor. This may include: a stability map of the land, a set of profitability projections based upon various comparative rates of fertilizer application from high to low zones, suggested options for how to approach unstable and low-yield zones, software patches and/or instructions for how a prescription map would be installed and used and the resulting “as-applied” data returned to the company performing the method. In some embodiments, an optimal recommended prescription map may be included.

A stability map for the land may be created in any of the techniques described herein, such as using remote sensing techniques (including, e.g., satellite imagery or drone images), actual yield data provided by the farmer, both, or other techniques known in the art.

In some embodiments, the requestor may be provided with several options for how to approach unstable and/or low yield zones, such as: not planting those zones at all and allowing them to return to a natural/wild state; planting cover crops in those zones; planting the zones but not fertilizing them; planting the zones but fertilizing at fewer instances than other zones; and/or planting the zones but applying less fertilizer at each scheduled application. Along with these options, the requestor may also be given various projections of the impacts of selecting each option, such as: total reduced greenhouse gas emission, total N fertilizer savings, total predicted yield, or similar information. Such projections may also be given in a map format, on a zone-by-zone basis, or geographic basis.

For example, a report including and/or based upon variations of the maps of FIG. 5 could be provided. Several variations of the ‘N-applied’ map could be provided, showing no/less/more application of N fertilizer in the low or unstable zones. The optional variations of the N-applied map would then reflect changes in the ‘N-savings’, ‘Carbon Credit’, and ‘Cash from Carbon Credit’ maps. In some embodiments, a predicted yield map and a total profitability map may also be provided. This could be done in a report format, or via an interactive web site or other application which could allow a customer to dynamically vary the highest and lowest levels of N fertilizer (e.g., via slider bars, text boxes, or other interface) to be applied and see the impact on N Savings, Carbon Credits, Cash from Carbon Credits, Yield, and Profitability.

In other embodiments, the requestor may optionally be asked at step 616 to provide specific input on the extent to which low yield or unstable zones should be fertilized or planted, or to simply select one of the options presented in step 614. The requestor's preferences and selections can then be taken into account when generating optimal prescription maps.

In some embodiments, the requestor may be provided with several alternative options for how to utilize unstable and/or low yield zones, apart from simply eliminating or reducing fertilization; using a cover crop or alternative crop; allowing native vegetation; or the like. For example, the method may determine one or more zones are unstable and/or low yield, and the requestor is suggested not to continue regular growing/fertilization habits in those zones, such as via the processes described above. The method may further determine that the one or more zones are suitable for an alternative renewable energy source (e.g., a wind turbine and/or solar panel) and the requestor is provided with a recommendation to utilize the unstable and/or low yield zone with renewable energy sources as an alternative to planting in the zone. The method may determine a particular zone is suitable for renewable energy sources based on, for example, the stability of the zone, an area of the zone, solar radiation data associated with the zone, wind capacity data associated with the zone, and the like. Along with these options, the requestor may also be given various projections of the impacts of selecting each option, such as: total reduced greenhouse gas emission, the impact on N Savings, Carbon Credits, Cash from Carbon Credits, Profitability, or similar information. Such projections may also be given in a map format, on a zone-by-zone basis, or geographic basis.

At step 618, the method determines whether the selections from the requestor reflect the optimal prescription for the land of interest. If the user declined the optimal prescription, or requested modifications (e.g., planting in LS zones despite a recommendation not to do so, or increasing the minimal fertilizer application for LS or U zones) at 620, then the method generates a new prescription map at 624 according to the user's request and sends it to the user at 626. If the user accepted the original optimal prescription map 622, then the map may be sent to the user at 626 if not previously done. The prescription map sent to the user may be in a format that can be installed on an agricultural sprayer truck capable of dynamic variable fertilizer application. In other words, when the prescription map is installed on the sprayer, the onboard controller of the sprayer will automatically and dynamically adjust the valves and spray rate of its nozzles to cause the prescribed amount of fertilizer to be sprayed onto the specified zones of the agricultural unit or land of interest.

At step 628, the method waits to receive data from the requestor indicating actual amounts of N fertilizer applied, based on the chosen prescription map. In some embodiments, the farmer or land manager may obtain an “as-applied” file from the fertilizer equipment that indicates a mapping of actual application of N fertilizer, then upload that file via a web portal. Many existing commercial fertilizer sprayers will automatically generate such a file. To promote ease of use, the software operating the web portal may accept multiple formats of “as-applied” files (e.g., the native file format from a commercial sprayer made by, e.g., John Deere, Hagie, Miller, Hardie, or Case), then pre-process them to extract spatial as-applied data for uniform usage and comparison to stability maps and target prescription amounts.

In other embodiments, a software update or patch may be provided for the fertilizer application equipment so that a custom “as-applied” file format is generated. This file could be formatted so as to allow for security, immutability, and/or verification of the stored data, such as in a blockchain format. For systems utilizing consistent, verifiable file formats, the fertilizer sprayer/equipment may have a software patch or upgrade installed that operates on-board to output an individual verifiable data file (e.g., via a cellular, wifi, or other wireless connection) or simply append “as-applied” data to a blockchain associated with the fertilized land. Alternatively, for spraying equipment that does not natively contain the capability to generate “as-applied” data, a retrofit kit may be supplied that connects to an existing sprayer such that it manages and records the opening/closing of valves for the spray heads of a sprayer, pressure, flow rate, and the like so as to generate as-applied data.

At step 630, the method may optionally continue to monitor conditions relating to growth of crops on the land of interest. For example, the method may monitor: weather (including daily temperature highs and lows, average daily temperature, average weekly temperature, amount of daily sunlight vs. cloud cover, average humidity, amount of total rainfall, volume of rainfall during individual storms, and the like) for the land of interest; reflectance data from remote sensing (e.g., drone imaging or satellite imaging); individual crop height measurements uploaded by the farmer for a number of specified locations within each type of zone; and the like.

From these measurements (or by merely scheduling), the method may then propose to the farmer prescriptions for subsequent, in-season fertilization at step 632. These proposals may be auto-generated or as requested by the farmer. In some implementations, the SALUS method (or other methods as discussed above) can be used to prescribe fertilizer application maps for in-season fertilization. The prescription map can thus be updated to reflect actual, in-season conditions for the specific farm or region at issue. This can allow further savings of N fertilizer in two respects: first, N fertilizer savings may be achieved through spatially tailored application of fertilizer in accordance with stability zones as described above, with LS zones receiving generally less fertilizer than HS or MS zones; second, N fertilizer savings may be achieved with respect to unstable zones. For unstable zones, acquired in-season data can be leveraged to determine whether the unstable zone will have a productive yield or not for this particular growing season. Where crops in unstable zones of a farm have experienced weather, washout, or other conditions not conducive to a productive yield for that zone (e.g., as evidenced by historical data), or the crops are measured as not having sufficient early growth to result in a yield as productive as desired (e.g., as evidenced by remote sensing or on-premises measurements), fertilizer application can then be reduced or stopped altogether for the unstable zones in the prescription maps for future applications in that growing season.

At step 634, the method can obtain a farmer's confirmation of the proposed prescription map 636 or alternatively can obtain requested modifications 638 from the farmer. If modifications are requested, then the in-season prescription map can be modified accordingly at step 640 as described above in connection with step 624. The prescription map can then be sent at step 642 to the farmer, directly to a contract provider that fertilizes or manages the land, or directly to the sprayer equipment or kit via over-the-air connection.

At step 644, the method then receives as-applied data corresponding to the second prescription map, in a manner similar to that of the first as-applied data. This process can then iterate for subsequent fertilizer applications at step 646 during a season. At the end of the season (or at various points during a season, such as after each fertilizer application, every other fertilizer application, or dynamically as a threshold N-savings is achieved), the as-applied data can be processed to determine N-savings at step 648. In some implementations, this is done in a verifiable way, such as through a blockchain, a public record (e.g., county land records, or state agriculture agency records), or other record so that future use of this data to justify a carbon credit sale can be preserved.

Next, assumed CO₂/N₂O reduction can be calculated at step 650 (or equivalent greenhouse gas or other environmental benefits). Based upon the type of fertilizer applied, and the relative reduction in N-applied as between the high yield (HS) zones and reduced zones (e.g., LS, MS, U, etc.), total CO₂/N₂O reduction can be computed using known methods such as: IPCC emission factor, where 1% of N fertilizer applied is lost as N2O. 1 kg of N2O is equivalent to 300 kg of CO2. It should be understood that other methods of calculating N2O emissions may be utilized, such as methods that more particularly take into account site factors affecting loss of N2O (soil conditions, temperature, etc.). From total CO₂/N₂O reduction, the equivalent number of carbon credits can be measured. Records relating to each credit can be associated with the underlying N-reduction data, such as a blockchain record or other verification as discussed above.

At step 652, the carbon credits can then be sold in a suitable marketplace such as the California Cap and Trade System or the European Union Emission Trading Scheme (EU ETS). As part of this step, the verified N-reduction data and calculated CO₂/N₂O reduction that supports carbon credits can be provided to the appropriate verification body. Reduced N application and CO₂/N₂O reduction for multiple farms, regions, states, etc. can be aggregated to support sales of carbon credits. At step 654, the proceeds from sale of the credits can then be allocated to users of the system. When proceeds are remitted, at the end of a growing season, or at another suitable time, information can then be provided to users regarding profitability of using the system. This may include calculated savings of reduced N fertilizer usage plus proceeds from carbon credit sales, less any impact on yield. A fuller profitability analysis can be provided if the farmer also provides actual yield data (e.g., directly from combine/harvester data) on a spatial basis over the farm.

In a similar way, other environmental benefits of reduced fertilizer usage can be leveraged. For example, as governments or other institutions implement credit programs to incentivize lessening of fertilizer runoff/leaching into waterways, groundwater, etc., a similar method of capturing precise data on savings of fertilizer application could be implemented.

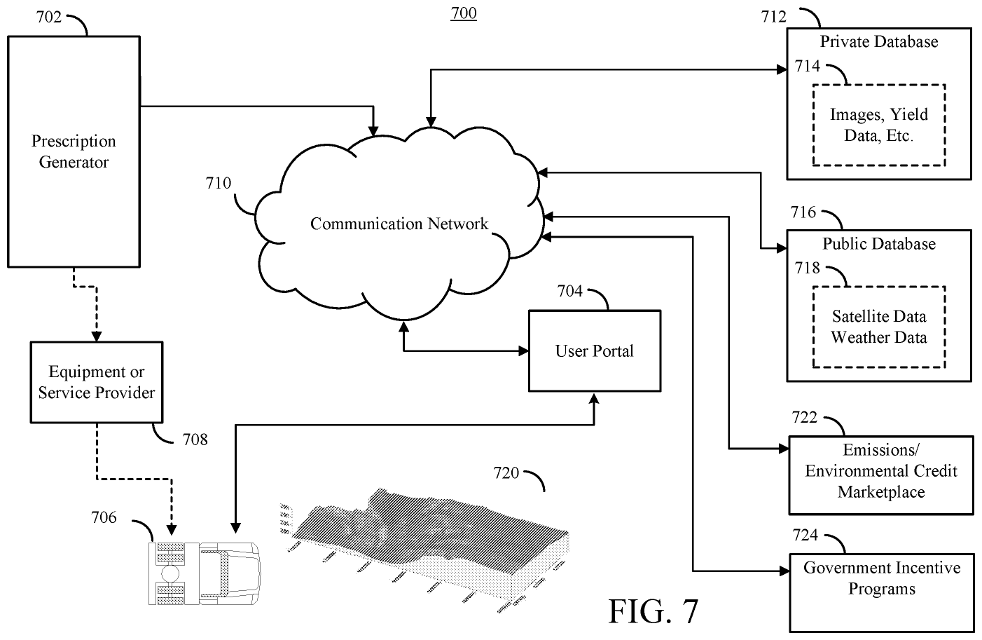

Referring now to FIG. 7, a system or network 700 is illustrated that can implement the various methods and advantages described herein. The system comprises a remote server 702, which includes at least one processor and at least one memory, with the server in remote communication with several other databases and servers (e.g., via an Internet and/or local/private network connection 710). The memory may include software code comprising instructions that cause the server to perform or interact with some or all of the steps of the methods described herein. For example, the server 702 may host a website and web portal 704 through which users interact with the services provided by the server 702. Alternatively, the server may communicate via remote connection (such as a cellular or other “over the air” connection) directly to commercial farming equipment 706 or via another connection (such as a web or Internet connection) to the networks of service providers 708 that fertilize farms.

The server 702 may be connected to a private database 712, which contains information 714 pertinent to the generation of prescription maps as described herein. For example, private database 712 may include remote imaging records, yield information, and impact of various types of N fertilizer on various types of crops (such as corn, soybeans, wheat, etc.) both with and without prescription maps as discussed herein. Database 712 may also store data correlating actual prescription maps, to actual as-applied N fertilizer data, and actual resulting yield on a farm-by-farm, or zone-by-zone basis, or in a manner that can be queried by a number of different attributes (e.g., location, climate, rainfall, weather, crop variety, etc.). This data can be used to implement better predictions of yield for future prescription maps. Database 704 can also store historical records for a given farm, such as profitability before and after use of prescription maps and precision conservation methods as described herein. These records could be provided to real estate services and farm management services for their business purposes. The private database may also contain profitability information for prior years, including crop prices, N-fertilizer prices, etc. Server 702 may also connect to repositories of public information 716. These databases may contain information 718 such as historical satellite imagery for relevant locales, historical weather data, crop prices, as well as similar data.

Server 702 interacts with users that desire tailored prescription maps that achieve precision conservation, as described herein. Users may include farms, such as farm 720, or may include group co-ops, farm management services providers, counties, university extensions, or government/non-profit conservation initiatives. Farm 720 may include at least one locally-stored device that requests and receives communications with the server 702. This can comprise a local computer, a WiFi connection that connects to a kit or equipment 706, or other suitable network connection. The farm 720 sends requested information to the server 702, and receives recommendations and prescription maps from the server 702. The prescription maps may be manually loaded into an onboard memory/controller of the sprayer equipment 706 (or alternatively, a retrofit kit) or automatically installed. The prescription maps will be tailored to the specific geography of the farm land 720. Thus, when the farm computer makes a request for a prescription map, some of the information the farm computer may provide to the server 702 includes: a description of the land parcel, the type of spraying equipment 706, the desired type of fertilizer, the crop type, planting date, irrigation schedule, and similar information.

The server 702 may utilize information concerning the farm 720 provided by the farm computer to access satellite or other remote imaging data from a remote repository 712, 716. This can be done to develop stability maps for the farm 720, initial prescription maps, and subsequent in-season prescription maps. The server may also be in communication with an exchange marketplace or auction site 722 to verify and sell carbon credits. In some embodiments, the server 702 may communicate directly with the marketplace 722 to verify sales of the carbon credits and collect the proceeds for distribution to farms. In other embodiments, the server 702 may simply communicate with a third party verification service. The farms may then collect remuneration for their carbon credits directly. Similarly, the server 702 may communicate with networks of a government or similar agency that provides incentive programs for greenhouse gas reduction or carbon sequestration 724.

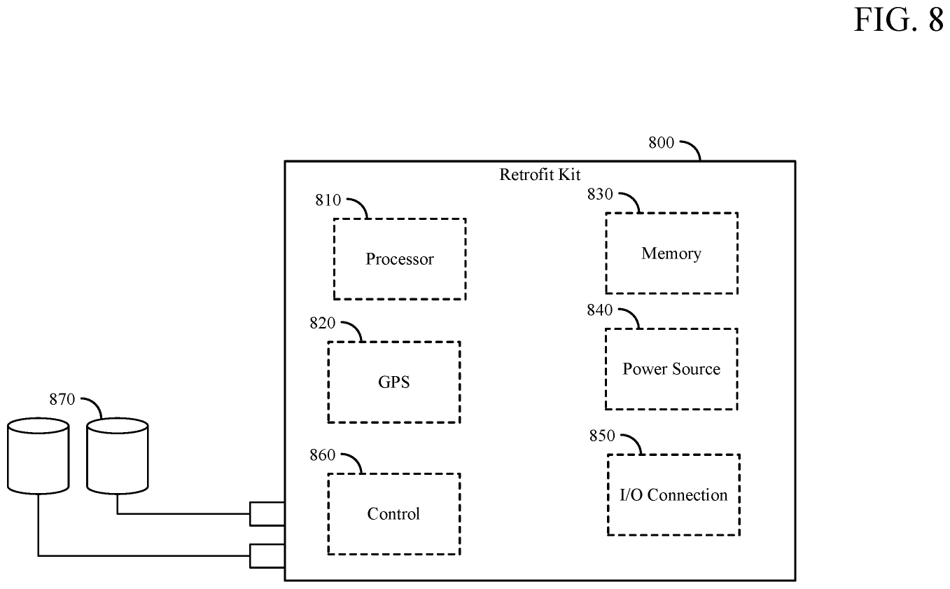

Referring now to FIG. 8, a kit 800 is shown for retrofitting an existing sprayer to allow it to automatically and dynamically implement a prescribed fertilizer application over a farm. The kit may include a processor 810, a positioning device (e.g., a GPS locator) 820, a memory 830, a power source or power input 840, an I/O connection (e.g., a WiFi connection, USB connection, cellular connection, or the like) 850, and optional control connections 860 to a set of servo motors or other devices 870 to mechanically operate the valves of the spray heads. The processor 810 may receive input from the GPS locator and determine where the sprayer equipment is located relative to the farm. Software installed on the memory 830 may indicate to the processor 810 the length of the spray booms and location of the spray heads, so the processor can assess where fertilizer will be sprayed by each spray head on the farm, as the sprayer drives across the farm. A prescription map may also be installed on memory 830, so that the processor 810 can send control signals to the motors 870 (e.g., via control connections 860) to increase or decrease the flow of fertilizer spray according to the prescriptions for the farm's specific zones. Memory 830 can record output of optional flow meters attached to the spray heads to generate verifiable data of the amount of fertilizer sprayed at each location of the farm. This data can be obtained from the kit 800 via the I/O connection 850 to be supplied to a service that obtains carbon credits.

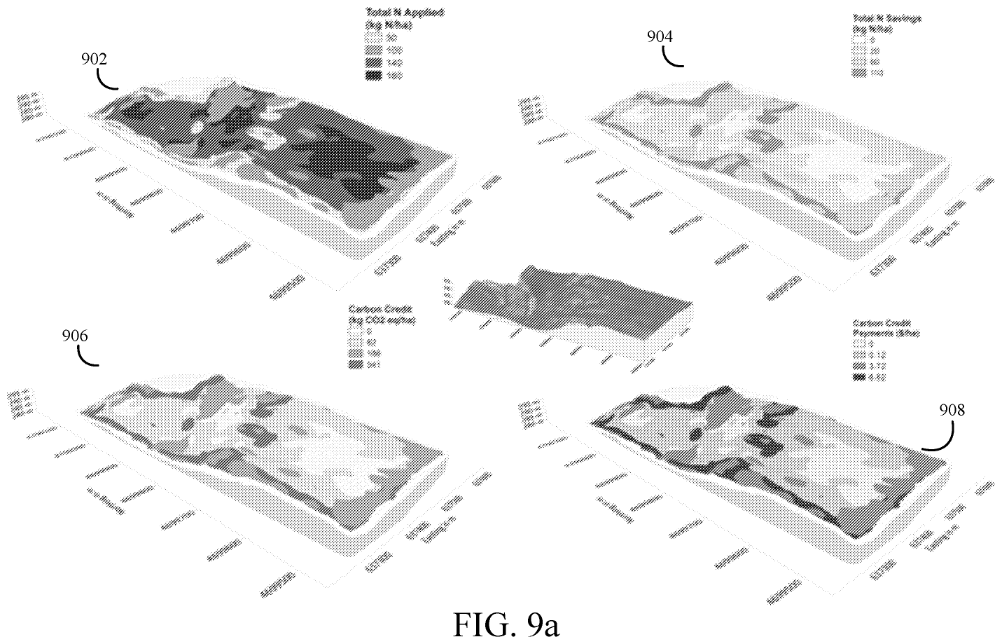

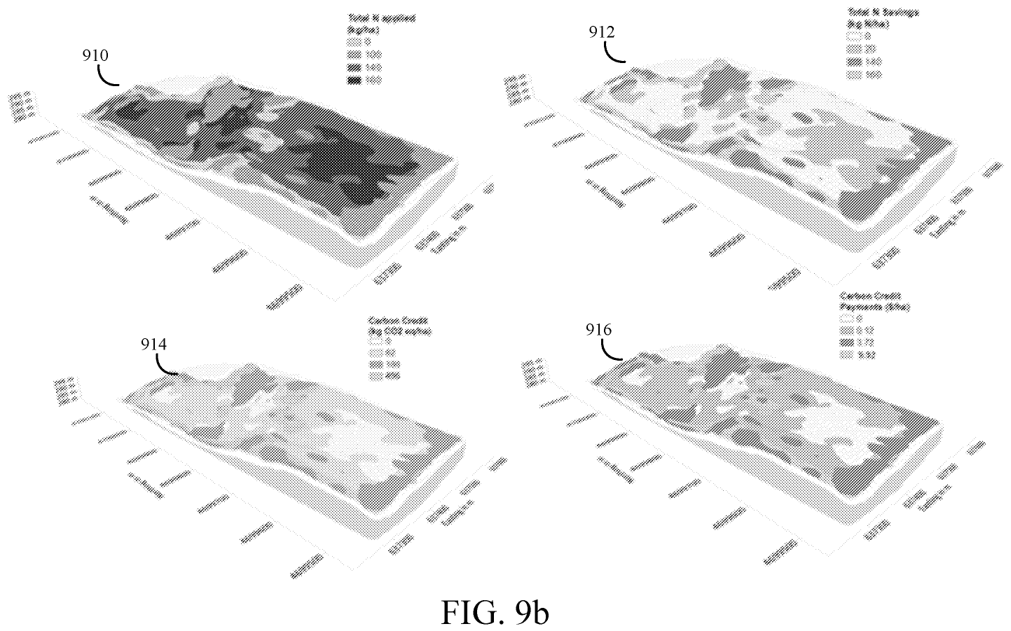

Referring now to FIG. 9, two sets of maps (panels a and b) are shown. The maps of FIG. 9 a include a map 902 of total N applied, as-applied spatially over an agricultural area. This map may be generated from data obtained using the methods described above, and could be provided to a user of prescription services in report format. As shown, the minimum amount of N applied is 50 kg N/ha, and the maximum is 160 kg N/ha. Map 904 shows total N savings, based upon N-applied in map 902. Map 906 shows carbon savings in terms of carbon credits (e.g., kg of CO2 saved/ha). Map 908 shows the value of those carbon credits in $/ha—illustrating that the areas of lowest N-applied generate the most carbon credit value.

FIG. 9b includes a set of maps that show similar information, but in a scenario where no N fertilizer was applied at all to low yield/stable zones. In map 910, actual N-applied is shown spatially over an agricultural area. The lowest amount of N in this experiment was 0. Map 912 shows the N savings due to such application, with the highest amounts of N savings being 100% of the highest amount of N applied in map 910 (i.e., 160 kg N/ha saved). Map 914 shows carbon credits available based on such N-savings, and map 916 shows carbon credit values over the farm. As shown, the maximum values of carbon credits correlate with the zones in which no N-fertilizer was applied.

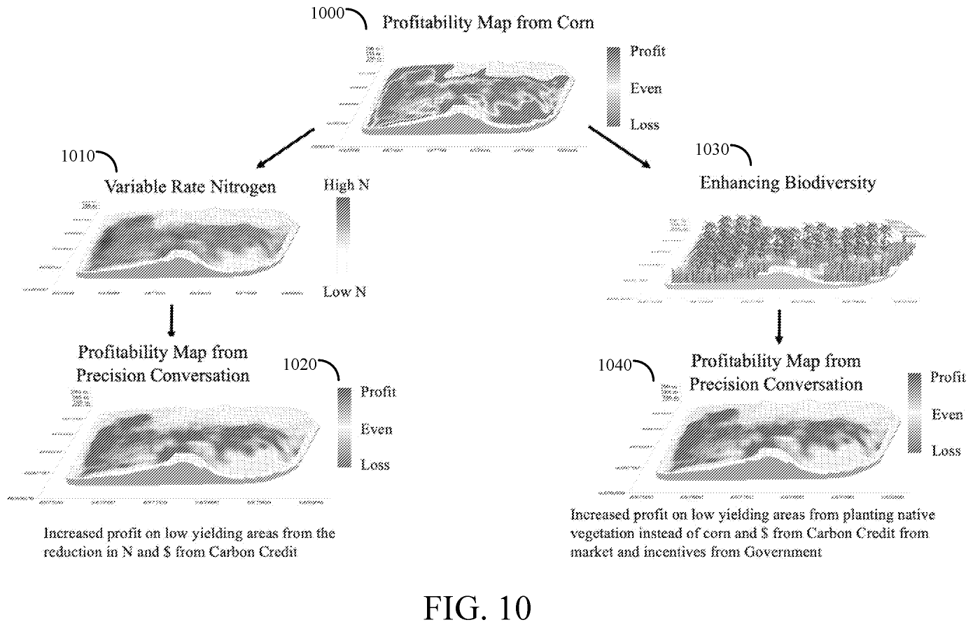

Referring now to FIG. 10, a sequence of maps is shown, illustrating an approach in which native or curated vegetation is grown in place of the crop of interest in certain zones. First, map 1000 depicts a profitability map for a given agricultural area. The map depicts profitability spatially distributed over the agricultural area, given conventional farming techniques (e.g., uniform application of N-fertilizer, crops planted over the entirety of the agricultural area). Some zones consistently exhibit a loss, while others consistently exhibit profit. Map 1010 shows a variable rate nitrogen map for the same agricultural area. This may be a prescription map, or other data that is provided to an agricultural operation. As shown, there are zones of the agricultural operation that are scheduled to receive no N fertilizer application. These could be low/stable zones, unstable zones, or other zones defined in a given hierarchy that are estimated not to be reliably profitable based upon growing conditions, the specific land at issue, N application etc. This decision and mapping can be determined in accordance with the methods discussed above. The following map 1020 shows what the expected profitability would be for the same agricultural area is the variable rate nitrogen were applied in lieu of conventional techniques. This profitability map could be generated as described above. As can be seen, the zones that were consistently unprofitable under conventional techniques (dark areas in map 1000) are no longer unprofitable. In other words, there is increased profit on low yielding areas from the reduction in N application plus the value of carbon credits. Alternatively, a prescription map 1030 could be provided for the agricultural area in which other crops or native vegetation are prescribed to be planted in lieu of the commercial crops in the low or unstable zones of the agricultural area. Map 1040 shows that utilizing such alternatives s in lieu of the commercial crop does not affect, or improves profitability. In other words, the map 1040 demonstrates that there is an increased profit for low yield zones/areas due to planting native vegetation rather than crops (reducing all costs of farming those zones) plus the revenue from the value of carbon credits derived from reduced/no N application in those zones plus any available incentives for growth of native vegetation. For example, plants that assist in erosion control, water retention, etc. could be selected and prescribed for the affected zones. Biodiversity is improved by not simply growing the crop of interest throughout the entire farm.

By not planting crops at all in low/stable or similar zones of undesirable yield characteristics, the profitability determination for those zones is affected differently than the profitability of other zones in which crops will still be grown. For example, savings in seed, time/resources spent in tilling and land management, irrigation, etc. must be accounted for. Likewise, the fact that no harvest will be obtained must also be taken into account. Thus, profitability map 1040 can be tailored to take these factors into account, and can be included as an option for a user requesting prescriptions that might desire alternatives. Furthermore, cover crops and native vegetation could in some instances generate eligibility for further carbon sequestration incentive programs.

In some embodiments, a user interface or portal may be provided to a user, in which maps such as those shown in FIG. 10 can be presented to a user to illustrate options for N-fertilizer prescriptions and their resulting impact on profitability. For example, a service could determine stability and historical profitability for a farmer's land on a spatial basis. Based on this determination, a service could visually illustrate to a farmer what a given prescription would cause in terms of profitability changes. A user could adjust prescription characteristics, such as high/low N-fertilizer rates, use of cover crops, use of native vegetation, etc., and then be presented with data and illustrations of the results of those adjustments, including impact on yield, impact on N-fertilizer savings, N2O emission reductions, carbon credits, and profitability.

Alternatively, in some embodiments, a user that has already determined to reduce use of available acreage in favor of a renewable energy installation (or any other use, such as alternative crops, dividing parcels, etc.), can utilize the systems and methods described herein to select which segments of a farm or other property to sacrifice for the alternative purpose. For example, even if no portions of a farm are low/stable, low/unstable, etc. (or otherwise clearly unprofitable or inferior), a user may still want to know the least profitable zones of a farm (relative to the rest of the farm) so that the lesser-profitable zones can be sacrificed to, e.g., a wind turbine. Accordingly, a dynamic user interface could be provided, to allow a user to select areas on a profitability map or satellite map that would potentially be removed from crop growth purposes, and select alternative uses for that land. E.g., a user might select an area of land the size of a wind turbine foundation and an access area, and the interface may provide to the user impact on overall profitability for the entire farm. The interface may take into account positive revenue generation from power generation, available government incentives and rebates and the like (including potential carbon reduction credits, if available), as well as savings from no longer planting and growing crops, against loss of potential revenue from the expected harvest that would otherwise have been available for that land. The interface may also predict for the user the optimal locations on a plot of land to devote to non-farming purposes.

Various designs, implementations, and associated examples and evaluations of a system for precision conservation through reduction of greenhouse gas in agricultural operations are described above. However, it is to be understood the present invention has been described in terms of one or more preferred embodiments, and it should be appreciated that many equivalents, alternatives, variations, and modifications, aside from those expressly stated, are possible and within the scope of the invention.

What is claimed is:

1. A method for reducing nitrogen application to agricultural land, comprising:
determining yield stability for at least two zones of an agricultural land;
generating a nitrogen fertilizer prescription for the agricultural land, comprising different fertilizer applications for each of the at least two zones;
receiving an indication of actual nitrogen fertilizer application at the agricultural land corresponding to the prescription;
determining a reduction in nitrogen fertilizer from the indication; and
selling carbon credits corresponding to the reduction in nitrogen fertilizer.

2. The method of claim 1, wherein determining yield stability further includes determining at least two of a high/stable, medium/stable, low/stable, and unstable zone for the agricultural land, and wherein the nitrogen fertilizer prescription includes a first application rate for high/stable or medium/stable zones that is higher than a second application rate for the low/stable zones.

3. The method of either of claim 1 or 2, wherein the fertilizer prescription includes at least one of: a recommendation of low fertilizer application for a low/stable zone, no fertilizer application for a low/stable zone, planting cover crop in a low/stable zone, or allowing native vegetation to a overtake low/stable zone.

4. The method of claim 2 further comprising generating at least one of:
a profitability map for the agricultural land, the profitability map taking into account the determined yield stability of the at least two zones as well as use of the fertilizer prescription; and
an overall profitability of the agricultural land taking into account the determined yield stability of the at least two zones as well as use of the fertilizer prescription.

5. The method of any of claims 1-4, further comprising generating a recommendation to devote at least a portion of at least one of the at least two zones for a non-crop purpose, based upon at least one of yield stability, fertilizer prescription, and profitability information.

6. The method of claim 5, wherein the non-crop purpose includes solar power generation, wind power generation, or native vegetation.

7. The method of claim 1, wherein the fertilizer prescription comprises an application file that correlates geographic information of the agricultural land with the at least two zones and a nitrogen application rate for each of the two zones.

8. A system for precision conservation comprising:
at least one processor;
at least one memory in communication with the processor, the at least one memory having stored thereon a set of instructions which, when executed, cause the processor to:
receive a request for a fertilizer prescription for a crop to be grown on an agricultural area of interest;
determine a crop yield stability map for the agricultural area of interest;
send at least one proposed prescription to a remote computer associated with the agricultural area of interest;
receive data corresponding to at least one actual fertilizer application for the agricultural area of interest; and
determine a reduction in greenhouse gas emission based upon the at least one fertilizer application.

9. The system of claim 8 wherein the instructions further cause the at least one processor to receive data concerning the agricultural area of interest from a remote computing device associated with the agricultural area of interest.

10. The system of claim 8 wherein the instructions further cause the processor to send a proposed fertilizer prescription in a file format that can be used to instruct different fertilizer application rates by an agricultural sprayer equipment capable of variable fertilizer application.

11. The system of claim 10, wherein the different fertilizer application rates of the fertilizer prescription file vary according to at least two zones of the crop yield stability map.

12. The system of claim 10, wherein the instructions further cause the processor to generate a record of greenhouse gas reduction utilizing the data corresponding to the at least one actual fertilizer application, and send the record to a server associated with a carbon credit exchange.

13. The system of claim 10 wherein the instructions further cause the processor to identify at least one section of the agricultural area of interest that is optimal for a non-crop purpose.

14. The system of claim 13, wherein the instructions further cause the processor to generate a recommendation for use of the at least one section including at least one of: solar power generation, wind power generation, or native vegetation growth.

15. The system of claim 14, wherein the instructions further cause the processor to generate a profitability assessment for the agricultural land of interest, comparing profitability of continued uniform fertilization for crop growth for all of the agricultural land of interest versus profitability of fertilization according to the proposed prescription and the recommendation for the non-crop use of the at least one section of the land.

16. A kit comprising:
at least one processor;
a connection to receive data from a location positioning system;
a valve controller adapted to connect to valves of a fertilizer sprayer; and
a memory connected to the processor, having a set of instructions stored thereon which, when executed by the processor, cause the processor to:
obtain real time location information from the connection to the location positioning system;
send controller signals to the valve control to adjust spray application of a fertilizer to be sprayed by the sprayer at zones of a farm according to a fertilizer prescription stored in the memory for that farm; and
record data indicative of the applied amounts of fertilizer over the farm.
